(19) United States
(12) Patent Application Publication
(10) Pub. No.: US 2013/0054144 A1
(43) Pub. Date: Feb. 28, 2013

(54) Distribution Feeder Outage Reduction

(71) Applicant: Kenneth James Caird, Atlanta, GA (US)

(72) Inventor: Kenneth James Caird, Atlanta, GA (US)

(73) Assignee: GENERAL ELECTRIC COMPANY, Schenectady, NY (US)

(21) Appl. No.: 13/215,548

(22) Filed: Aug. 23, 2011

(51) Int. Cl. G06F 19/00

(52) U.S. Cl. 702/4; 702/3

(57) ABSTRACT

Systems and methods for distributed feeder outage reduction are usable to reduce power outages by tracking weather conditions and/or receiving weather condition information. Such systems and methods can be used to control protective relays and/or recloser breakers of utility systems to increase relay trip levels during storm conditions. Additionally, normal operating settings may be implemented when weather activity is not predicted to impact such components.

### FIELD OF THE INVENTION

Embodiments of the invention relate generally to power outage reduction, and more particularly, to utilizing adaptive protection relay settings to reduce power outages.

### BACKGROUND

Public utility commissions regularly rate electric distribution utilities based on the number and duration of outages incurred. Thus, utilities may report performance against a set target or standard to the commissions. A large percentage of power outages are storm related, and relays often trip due to lightning-induced surges. Reducing power outages caused by storms, however, is a constant concern. Finding ways to reduce power outages continues to be a priority.

### SUMMARY

Some or all of the above needs and/or problems may be addressed by certain embodiments of the invention. Certain embodiments may include utilizing adaptive protection relay settings to reduce power outages. According to one embodiment of the invention, there is disclosed a system operable to receive weather activity information, receive geographic location information of at least one plant component, determine when weather activity will affect the operation of the at least one plant component, and transmit setting information to the at least one plant component based at least in part on the determination.

According to another embodiment of the invention, there is disclosed a method for receiving weather activity information, receiving geographic location information of at least one plant component, determining when weather activity will affect operation of the at least one plant component, and transmitting setting information to the at least one plant component based at least in part on the determination.

Further, according to another embodiment of the invention, there is disclosed one or more computer-readable media storing computer-executable instructions that, when executed by at least one processor, configure the at least one processor to perform operations for receiving weather activity information from a data service; receiving geographic location information of at least one plant component from a geographic information system; determining, based at least in part on the weather activity information, weather activity, wherein the weather activity comprises a storm location, a storm direction, a storm speed, a number of lightning strikes, a frequency of lightning strikes, and/or an intensity of lightning strikes; predicting, based at least in part on the weather activity and the geographic location information of the at least one plant component, if a storm will affect operation of at least one plant component; and transmitting, to a protection relay coupled to the at least one plant component, adaptive protection relay setting information if the prediction indicates that a storm will affect the at least one plant component.

Other embodiments, systems, methods, aspects, and features of the invention will become apparent to those skilled in the art from the following detailed description, the accompanying drawings, and the appended claims.

### BRIEF DESCRIPTION OF THE DRAWINGS

The detailed description is set forth with reference to the accompanying drawings, which are not necessarily drawn to scale. In the figures, the left-most digit(s) of a reference number identifies the figure in which the reference number first appears. The use of the same reference numbers in different figures indicates similar or identical items.

FIG. 1 is a block diagram of an illustrative system for distribution feeder outage reduction, according to an embodiment of the invention.

FIG. 2 is a block diagram of a computing environment showing an illustrative system in which distribution feeder outage reduction can be implemented, according to an embodiment of the invention.

FIG. 3 is a flow diagram illustrating details of a method for performing distribution feeder outage reduction, according to an embodiment of the invention.

### DETAILED DESCRIPTION

Illustrative embodiments of the invention will now be described more fully hereinafter with reference to the accompanying drawings, in which some, but not all embodiments of the invention are shown. The invention may be embodied in many different forms and should not be construed as limited to the embodiments set forth herein; rather, these embodiments are provided so that this disclosure will satisfy applicable legal requirements. As noted above, like numbers refer to like elements throughout.

Illustrative embodiments of the invention are directed to, among other things, distribution feeder outage reduction. As an overview, relay devices may be utilized to monitor and/or control voltage regulators, breakers, and/or recloser breakers of distributed power systems. Relay devices may include, but are not limited to, protective relays, induction disk relays, shaded-pole magnet relays, operating and restraint coil relays, solenoid-type relays, telephone-type relays, phase-shifting network relays, or any combination thereof. Additionally, a substation controller, or relay controller, may control individual relays or groups of relays such that the relays are set with appropriate trip levels.

In some instances, substation and/or relay controllers may be remotely monitored and controlled. In this way, when weather conditions indicate that a storm is approaching, the relay controllers may be programmed to set relay trip levels to storm settings. Storm settings may allow higher voltage levels to pass through breakers and/or recloser breakers without causing outages. In this way, power outages may be reduced.

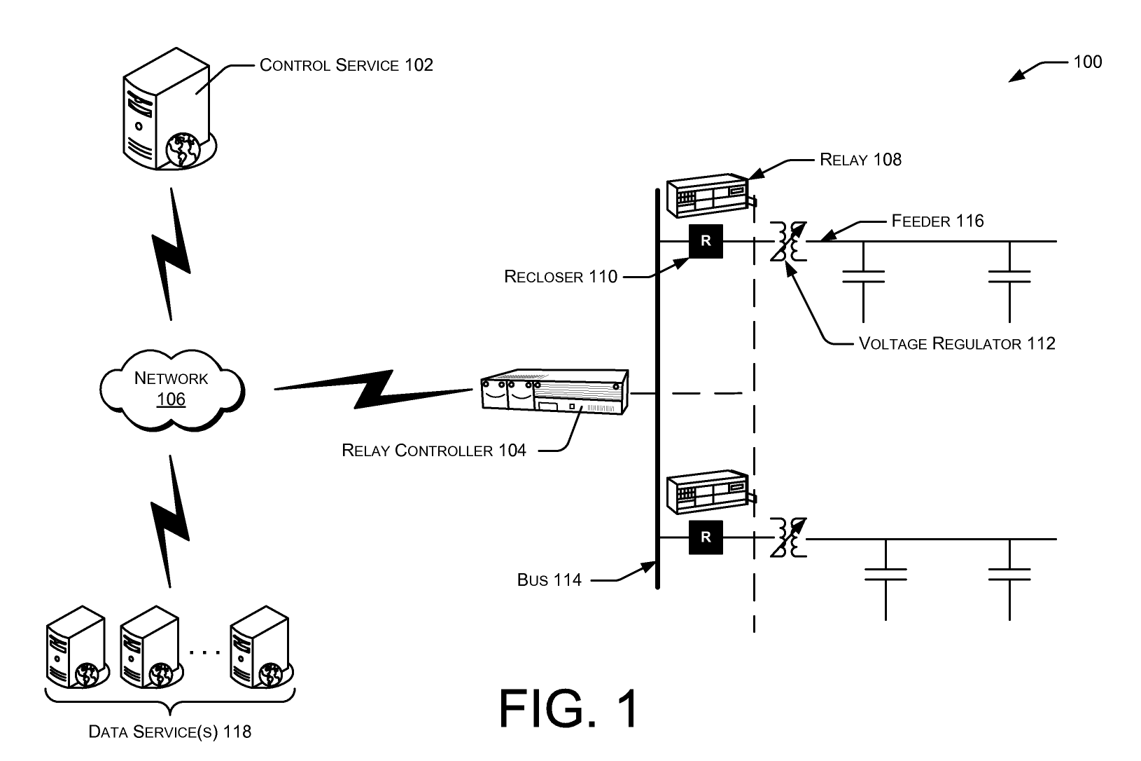

FIG. 1 depicts an illustrative architecture 100 in which techniques for distribution feeder outage reduction may be implemented. In architecture 100, a control service 102 may be configured to monitor and/or control a relay controller 104 via network 106, such as the Internet or other private or public network. The control service 102 may be implemented by any type of computing device. For example, a personal computer, main frame, web server, or mobile device may be configured to implement the control service 102. Additionally, the relay controller 104 may be any type of relay controller or substation controller that is capable of sending a signal to one or more relay devices, such as relay 108.

In some instances, relay 108 may be coupled to recloser 110 and/or voltage regulator 112. The recloser 110 may be a recloser breaker that is capable of resetting itself in the event that a voltage signal causes the recloser breaker to trip. By way of example only, the recloser 110 may also be coupled to a bus 114 that may provide electricity from a power grid or other power source and/or a feeder 116 that may receive electricity from the voltage regulator 112. As noted above, if lightning strikes certain components of architecture 100 while the relays are set on normal operating settings, a power outage may occur. However, in certain cases, when a relay 108 is programmed to set the recloser 110 to a higher trip value (e.g., a storm setting), a power outage may be avoided.

By way of example only, the control service 102 may also be in communication with one or more data service(s) 118. Data service(s) 118 may be any type of service that provides data, including but not limited to, weather data. In some instances, data service(s) 118 may include a Geographical Information System (GIS), a weather service, and/or a Distribution Management System (DMS) which may control a power grid. When data service 118 is a GIS, the GIS may scan weather service information, track utility components (e.g., the relay 108, the recloser 110, etc.), predict when and/or where storms may strike (i.e., determine when storms will impact utility components), and transmit this data to the control service 102. That is, in some implementations, the data service 118 may provide the information to the control service 102 so that the control service 102 can control the relay controller 104 based on this information. However, in other implementations, the data service 118 may merely transmit the weather data to the control service 102, and the control service 102 may predict when and/or where the weather will impact the equipment.

Further, when the data service 118 is a DMS, the control service 102 may rely on receiving information from a weather service and a GIS in order to effectively control the relay controller 104. In other embodiments, the data service(s) 118 may include all or any combination of a GIS, a DMS, and/or a weather service. Similarly, the control service 102 may receive information from any combination of the foregoing services and may be configured to perform any actions that are not provided by a data service 118, such as but not limited to collecting and/or predicting weather information, tracking and/or monitoring utility equipment, and/or controlling the power grid.

In some instances, the control service 102 may receive weather and/or weather tracking information from a data service 118 that indicates that weather may impact a particular utility component, such as somewhere along feeder 116. Additionally, the received information may indicate at what time and for how long the storm is predicted to occur. Once received, the control service 102 may transmit data to the relay controller 104 to instruct the relay controller to set the relay 108 to a storm setting. As such, the relay 108 may increase the trip level to a level that is higher than the normal operating trip levels. In this way, if lightning strikes any of the surrounding components, the breaker in the recloser breaker 110 may not trip, thus avoiding a power outage. The control service 102 may then wait for new information from the data service 118 indicating that the storm has passed, or it may calculate an amount of time for the storm based on the initial information received (i.e., based on how long the storm was predicted to last). Once the storm has passed and/or an indication has been received that the storm has passed (or is predicted to be over), the relay controller 104 may transmit data to the relay 108 to set the recloser 110 back to normal operating settings. In some examples, a storm setting may include adjusting an ANSI relay settings. Settings may be up or down depending on fuse saving schemes.

The technical effects of certain embodiments of the invention may include reducing power outages by controlling distribution feeder relays to handle storm surges when storms are predicted to impact utility components.

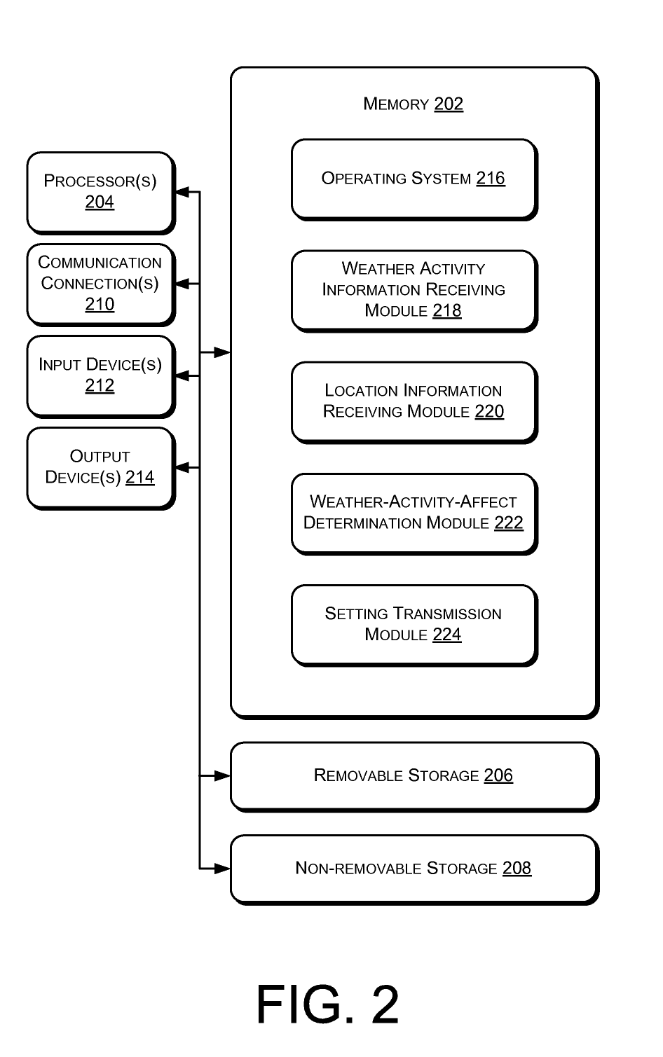

FIG. 2 provides an illustrative overview of one example computing environment 200, in which aspects of the invention may be implemented. The computing environment 200 may be configured as any suitable computing device capable of implementing distribution feeder outage reduction. By way of example and not limitation, suitable computing devices may include personal computers (PCs), servers, server farms, data centers, or any other device capable of storing and executing all or part of the control service 102 of FIG. 1.

In one illustrative configuration, the computing environment 200 comprises at least a memory 202 and one or more processing units (or processor(s)) 204. The processor(s) 204 may be implemented as appropriate in hardware, software, firmware, or combinations thereof. Software or firmware implementations of the processor(s) 204 may include computer-executable or machine-executable instructions written in any suitable programming language to perform the various functions described.

Memory 202 may store program instructions that are loadable and executable on the processor(s) 204, as well as data generated during the execution of these programs. Depending on the configuration and type of computing environment 200, memory 202 may be volatile (such as random access memory (RAM)) and/or non-volatile (such as read-only memory (ROM), flash memory, etc.). The computing device or server may also include additional removable storage 206 and/or non-removable storage 208 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 202 may include multiple different types of memory, such as static random access memory (SRAM), dynamic random access memory (DRAM), or ROM.

Memory 202, removable storage 206, and non-removable storage 208 are all examples of computer-readable storage media. For example, computer-readable storage media may include volatile and non-volatile, removable and non-removable media implemented in any method or technology for storage of information such as computer-readable instructions, data structures, program modules or other data. Memory 202, removable storage 206, and non-removable storage 208 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tapes, magnetic disk storage or other magnetic storage devices, or any other medium which can be used to store the desired information and which can accessed by the server or other computing device. Combinations of any of the above should also be included within the scope of computer-readable media.

However, in other embodiments, computer-readable communication media may include computer-readable instructions, program modules, or other data transmitted within a data signal, such as a carrier wave, or other transmission. However, as used herein, computer-readable storage media does not include computer-readable communication media.

The computing environment 200 may also contain communication connection(s) 210 that allow the computing environment 200 to communicate with a stored database, another computing device or server, user terminals, and/or other devices on a network, such as the control service 102, the data service(s) 118, and/or the relay controller 104 of FIG. 1.

The computing environment 200 may also include input device(s) 212 such as a keyboard, mouse, pen, voice input device, touch input device, etc., and output device(s) 214, such as a display, speakers, printer, etc.

Turning to the contents of the memory 202 in more detail, the memory 202 may include an operating system 216 and one or more application programs or services for implementing the features disclosed herein including a weather activity information receiving module 218 and a location information receiving module 220. The weather activity information receiving module 218 may be configured to receive weather activity information. By way of example only, weather activity information may include a temperature, humidity, barometric pressure, wind speed and direction, storm location, storm direction, storm speed, and/or a number, frequency, and/or intensity of lightning strikes for a given time period. In some aspects, the computing environment 200 may control the relay controller 104 of FIG. 1 based on this weather activity information. Additionally, the location information receiving module 220 may be configured to receive geographic location information of plant and/or utility components from a DMS or other power grid controller. That is, the DMS, or other data provider, may transmit location information to the computing environment 200 so that this information may be used in conjunction with the weather activity information.

The memory 202 may also include a weather-activity-affect determination module 222 and a setting transmission module 224. The weather-activity-affect determination module 222 may be configured to determine when weather activity is expected to affect and/or impact plant components, such as but not limited to the relay 108, the recloser 110, the voltage regulator 112, and/or the feeder 116. In some instances, the determination may be made based on the weather activity and/or the geographic location information received by the weather activity information receiving module 218 and/or the location information receiving module 220, respectively. However, in some instances, the determination may be made based on other factors and/or based on information received in other ways or previously stored. Further, the setting transmission module 224 may be configured to transmit setting information to the relay controller 104 or any other controller for setting the relay 108 of FIG. 1. In some aspects, the setting transmission module 224 may transmit storm settings for the relay 108, normal operating settings for the relay 108, or any other settings for controlling the relay 108 and/or the recloser 110. Additionally, while the setting transmission module 224 has been generally described as transmitting setting information to a controller, such as relay controller 104, it may also transmit setting information directly to relay 108 and/or recloser 110.

Various instructions, methods, and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example architecture 100 and computing environment 200 shown in FIGS. 1 and 2 are provided by way of example only. Numerous other operating environments, system architectures, and device configurations are possible. Accordingly, embodiments of the present invention should not be construed as being limited to any particular operating environment, system architecture, or device configuration.

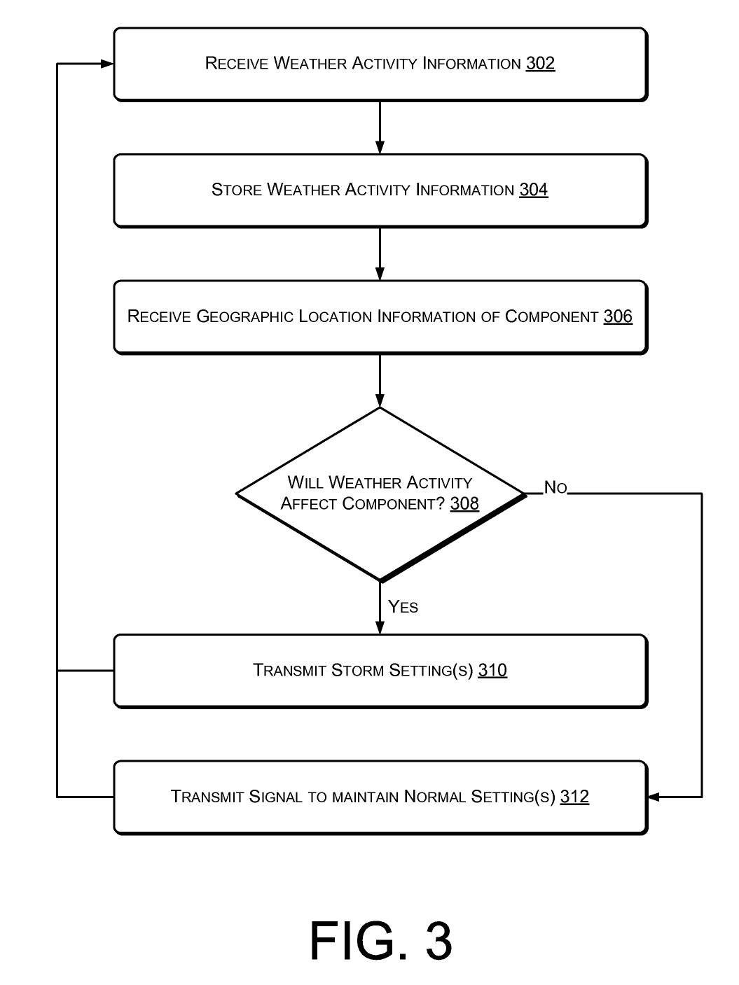

FIG. 3 is a flow diagram of an illustrative process 300 for implementing at least one embodiment of distribution feeder outage reduction, as described with reference to FIGS. 1 and 2. In one example, the illustrative control service 102, the illustrative relay controller 104, or the example computing environment 200 may perform any or all of the operations of process 300. This process is illustrated as a logical flow diagram, in which each operation represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

In this particular implementation, the process 300 may begin at block 302 in which the process 300 may receive weather activity information from another computing device, or web server, such as data service(s) 118. As noted above, data service(s) 118 may include a GIS, a DMS, and or a weather service. At block 304, the process 300 may store the weather activity information received at block 302. The process 300 may also receive geographic location information associated with plant/utility components at block 306. In some instances, this information may be received from a DMS that manages a power grid associated with the components.

The process 300 may determine whether weather activity will affect the components for which location information was either received or already known at decision block 308. This determination may be based on the weather information, the component location information, a combination of both, or based on a determination made by another source, such as the control service 102 and/or a data service 118.

If the process 300 determines, or is instructed, that the weather activity will affect the components, then the process 300 may transmit one or more storm setting(s) to the relay controller 104, or other component, at block 310. The process 300 may then continue to receive additional weather activity information by returning to block 302. In other embodiments, if the process 300 determines, or is instructed, that the weather activity will not affect the components, then the process 300 may transmit a signal to the relay controller 104, or other components, to maintain normal operating settings at block 312. The process 300 may then continue to receive additional weather activity information by returning to block 302. In some instances, the process 300 may be an iterative process that continues perpetually, during specific time periods, or when instantiated. However, in other instances, the process 300 may only iterate once, twice, or for a specific number of instances.

Illustrative systems and methods of distributed feeder outage reduction are described above. Some or all of these systems and methods may, but need not, be implemented at least partially by an architecture such as that shown in FIGS. 1-3. It should be understood that certain acts in the methods need not be performed in the order described, may be rearranged or modified, and/or may be omitted entirely, depending on the circumstances. Also, any of the acts described above with respect to any method may be implemented by a processor or other computing device based on instructions stored on one or more computer-readable storage media.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A system, comprising:
at least one memory that stores computer-executable instructions;
at least one processor configured to access the at least one memory, wherein the at least one processor is configured to execute the computer-executable instructions to:
receive weather activity information;
receive geographic location information of at least one plant component;
determine when weather activity will affect operation of the at least one plant component; and
transmit setting information to the at least one plant component based at least in part on the determination.

2. The system of claim 1, wherein the at least one processor is further configured to execute the computer-executable instructions to determine weather activity based at least in part on the weather activity information.

3. The system of claim 2, wherein the determination of when weather activity will affect operation of at least one plant component is based at least in part on the weather activity information and the geographic location information of the at least one plant component.

4. The system of claim 3, wherein the weather activity information is received from a data service.

5. The system of claim 3, wherein the weather activity information comprises a storm location, a storm direction, a storm speed, a number of lightning strikes, a frequency of lightning strikes, and/or an intensity of lightning strikes.

6. The system of claim 3, wherein weather activity affecting operation of the at least one plant component comprises a lightning strike on at least one plant component.

7. The system of claim 6, wherein the at least one plant component comprises electric transmission or electric distribution equipment.

8. The system of claim 6, wherein the at least one plant component comprises a protection relay coupled to electric transmission or electric distribution equipment.

9. The system of claim 3, wherein the setting information comprises adaptive protection relay setting information.

10. The system of claim 9, wherein the adaptive protection relay setting information comprises a trip setting to prevent false trips, wherein the trip setting is equal to or higher than a setting in place prior to the setting information being transmitted.

11. The system of claim 3, wherein the at least one processor is further configured to execute the computer-executable instructions to determine when the weather activity will not affect operation of the at least one plant component.

12. The system of claim 11, wherein the at least one processor is further configured to execute the computer-executable instructions to transmit a signal to the at least one plant component, wherein the signal instructs the at least one plant component to revert to a setting in place prior to the setting information being transmitted.

13. A method, comprising:
receiving weather activity information and storing the weather activity information in at least one memory;
receiving geographic location information of at least one plant component;
determining when weather activity will affect operation of the at least one plant component; and transmitting, based at least in part on the determination, setting information to the at least one plant component.

14. The method of claim 13, wherein the weather activity information is received from a weather data service.

15. The method of claim 13, wherein the weather activity information comprises a storm location, a storm direction, a storm speed, a number of lightning strikes, a frequency of lightning strikes, and/or an intensity of lightning strikes.

16. The method of claim 13, wherein the setting information comprises an adaptive protection relay setting.

17. The method of claim 16, wherein the adaptive protection relay setting comprises a trip setting to prevent false trips, wherein the trip setting is equal to or higher than a setting in place prior to the setting information being transmitted.

18. The method of claim 13, further comprising determining when the weather activity will not affect operation of the at least one plant component.

19. The method of claim 18, further comprising transmitting a signal to the at least one plant component, wherein the signal instructs the at least one plant component to revert to a setting in place prior to the setting information being transmitted

20. One or more computer-readable media storing computer-executable instructions that, when executed by at least one processor, configure the at least one processor to perform operations comprising:
receiving weather activity information from a data service;
receiving geographic location information of at least one plant component from a geographic information system;
determining, based at least in part on the weather activity information, weather activity, wherein the weather activity comprises a storm location, a storm direction, a storm speed, a number of lightning strikes, a frequency of lightning strikes, and/or an intensity of lightning strikes;
predicting, based at least in part on the weather activity and the geographic location information of the at least one plant component, if a storm will affect operation of at least one plant component; and
transmitting, to a protection relay coupled to the at least one plant component, adaptive protection relay setting information if the prediction indicates that a storm will affect the at least one plant component.
